(19) United States
(12) Patent Application Publication
(10) Pub. No.: US 2010/0133769 A1
(43) Pub. Date: Jun. 3, 2010

(54) WHEEL ASSEMBLY

(75) Inventor: ChangLing Wu, Jiaxing (CN)

Correspondence Address: COHEN & GRIGSBY, P.C., 625 LIBERTY AVENUE, PITTSBURGH, PA, 15222-3152, US

(73) Assignee: The Faucet Queens, Inc., Vernon Hills, IL (US)

(21) Appl. No.: 12/625,689

(22) Filed: Nov. 25, 2009

(30) Foreign Application Priority Data
Dec. 1, 2008 (CN) 200820168488.9

(51) Int. Cl. B62B 7/08; B60B 37/00; B23P 11/00

(52) U.S. Cl. 280/47.18; 301/132; 29/428

(57) ABSTRACT

A wheel assembly having a connecting jacket for attachment to a body and a wheel having an axle attached to a connecting pin is disclosed. The connecting jacket selectively receives the connecting pin for easy assembly and disassembly of a wheel on a body. A connecting pin having a U-shaped spring enclosed in a rectangular housing is disclosed. A cart having such a wheel assembly is disclosed. A method for removably attaching a wheel using the disclosed wheel assembly is also disclosed.

### CLAIM OF PRIORITY

This application is a U.S. National Application of Chinese Patent Application No. 200820168488.9, filed Dec. 1, 2008.

### FIELD OF THE INVENTION

Embodiments of the present invention generally relate to a wheel assembly and an easy to assemble cart.

### BACKGROUND OF THE INVENTION

To reduce volume and lower transportation costs, items, such as carts, are generally disassembled for packing and shipping. For example, wheels may be separated, such as larger rear wheels on carts. After purchasing, a consumer must assemble the item with wheels before using. As an example, many of the existing cart bodies are connected to the wheels with a horizontal axle that traverses the wheels and is secured with washers. The disassembly and assembly processes are complex, troublesome, and both time and energy consuming. Thus, there is a need for wheel assemblies that are easier to assemble and disassemble.

### SUMMARY OF THE INVENTION

In general, embodiments of the present invention relate to a wheel assembly and a cart with removable wheels that are easy to assemble and disassemble.

In one embodiment the present invention is directed to a wheel assembly having a connecting jacket with two openings and a wheel having an axle attached to a connecting pin. One opening of the connecting jacket is attached to a body fixture and the second opening is positioned to the side for selectively receiving the connecting pin. In a particular embodiment, the connecting pin has a U-shaped spring with balls on each end. The connecting pin may also have a housing surrounding the U-shaped spring. The second opening of the connecting jacket is shaped to fit the connecting pin. The second opening of the connecting jacket may have guidance slots on opposite walls to guide the balls of the U-shaped spring. The connecting jacket may also have a pressure sheet on opposite walls corresponding to the position of the balls of the U-shaped spring.

In another embodiment, the present invention is directed to a cart having at least one wheel assembly as described above. In particular the cart has four wheels, such as, for example, two rear wheels larger than the front wheels. The two rear wheels are connected to the cart with the disclosed wheel assembly.

Other embodiments relate to a method for removably attaching a wheel to a body utilizing the wheel assembly disclosed herein.

Those and other details, objects, and advantages of the present invention will become better understood or apparent from the following description and drawings showing embodiments thereof.

### BRIEF DESCRIPTION OF THE DRAWINGS

The accompanying drawings illustrate examples of embodiments of the present invention:

FIG. 1 is an exploded view of a wheel assembly;

FIG. 2 is an assembled wheel assembly;

FIG. 3 shows a wheel connecting jacket;

FIG. 4 shows a cross-section of a connecting pin having a U-shaped spring; and

FIG. 5 shows a cart with a wheel assembly embodied herein.

### DETAILED DESCRIPTION

In all of its embodiments and related aspects, the present invention generally pertains to a wheel assembly. Various embodiments of the present invention relate to a cart with removable wheels and methods of attaching a wheel to a body.

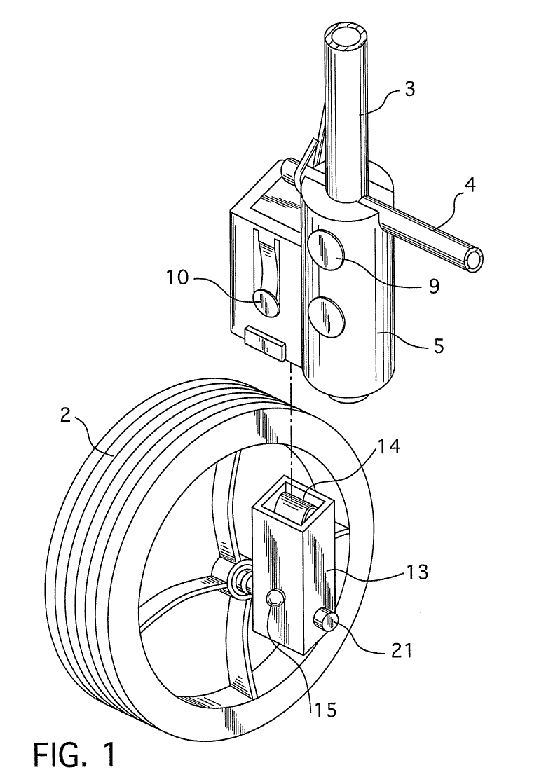

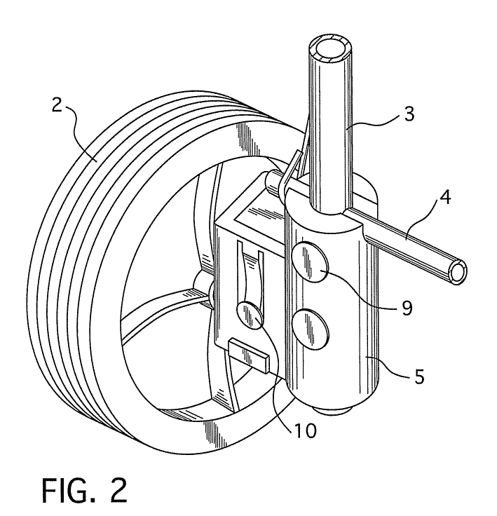

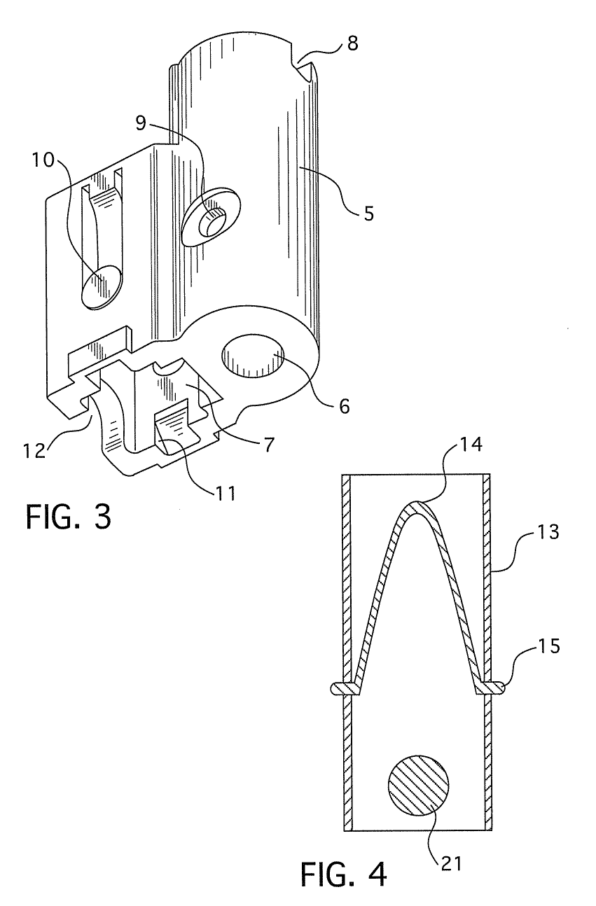

In one embodiment, the present invention is directed to a wheel assembly having a connecting jacket 5 and a wheel 2 having an axle 21 attached to a connecting pin 13, as shown, for example, in FIGS. 1 and 2. The connecting jacket 5 has a first opening 6 for attachment to a body fixture and a second opening 7 positioned to the outside relative to the first opening 6 for selectively receiving the connecting pin 13. See FIGS. 3 and 4. The first opening 6 is shaped to fit the body fixture, for example support members 3 and 4 in FIGS. 1 and 2, and must extend far enough to secure the body fixture to the connecting jacket 5. The connecting jacket 5 is fixedly attached to the body, such as for example by a screw through hole 9 (FIG. 3). The end of the connecting jacket opposite opening 6 may be closed or open. The second opening 7 is shaped to fit and selectively receive the connecting pin 13 and the opposite end of opening 7 may be closed or open, preferably the end is closed. In a preferred embodiment, the first opening 6 opens upward and the second opening 7 opens downward. In addition, for positioning the axle 21, connecting jacket 5 has a semi-circular slot 12 on the second opening 7. See FIG. 3.

In a particular embodiment, the connecting pin 13 has a U-shaped spring 14 with a ball 15 on each end. See FIG. 4. The connecting pin 13 may also have a housing, such as a rectangular housing with a square opening at the top near the pinnacle of the U-shaped spring 14, holes on opposite walls corresponding to the balls 15 of the U-shaped spring 14, and a passageway for the wheel axle 21. See FIGS. 1 and 4. In this example, the second opening 7 of the connecting jacket 5 is square shaped to fit the housing of the connecting pin 13. The second opening 7 also has a guidance slot 11 on opposite walls to guide the balls 15 of the U-shaped spring 14 into the second opening 7. See FIG. 3. The opposite walls of the connecting jacket 5 having the guidance slots 11 may also have a pressure sheet 10 with the lower end of the pressure sheet 10 corresponding to the balls 15 of the U-shaped spring 14. In this way the connecting pin 13, and thereby the wheel 2, is securely attached. However, when the pressure sheets 10, and thereby the balls 15 of the U-shaped spring 14, are compressed, the connecting pin 13 can be pulled from the second opening 7 of the connecting jacket 5; thereby removing the wheel from the body. Pressure sheet 10 may also have a receptacle or button to assist with compressing the balls 15 of the U-shaped spring 14 upon disassembly.

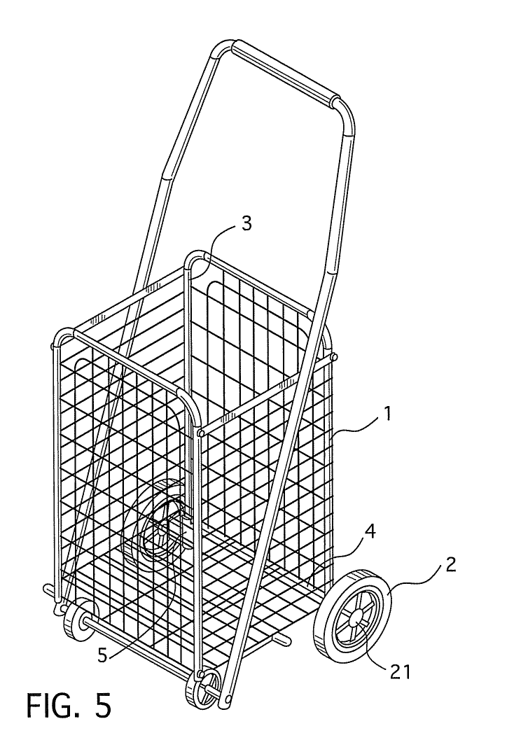

The above disclosed wheel assembly could be used for any body with wheels. Examples include, without limitation, carts, strollers, furniture, toys, chairs, etc. In an embodiment, the present invention is directed to a cart with wheels attached by means of the disclosed wheel assembly. See FIG. 5. Particularly, the cart has two smaller wheels on a fixed front axle and two larger rear wheels 2 removably attached by means of the disclosed wheel assembly. In this example, the connecting jacket 5 is attached to the bottom of the cart body support 3 via opening 6 with opening 7 to the outside for wheel attachment via insertion of the connecting pin 13 attached to the wheel axle 21. In addition, the connecting jacket has a semi-circular slot 8 to position the connecting jacket 5 with the bottom horizontal support member 4 of the cart body 1.

In another embodiment, a method for removably attaching a wheel to a body using the wheel assembly described above is disclosed. Connecting pin 13 attached to the axle 21 of the wheel 2 is inserted into opening 7 of the connecting jacket 5, which is attached to the body. Upon disassembly, pressure sheets 10 are compressed and connecting pin 13 pulled from the connecting jacket.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention.

The present invention has been described with reference to specific details of particular embodiments thereof. It is not intended that such details be regarded as limitations upon the scope of the invention except insofar as and to the extent that they are included in the accompanying claims.

What is claimed is:

1. A wheel assembly comprising a wheel having an axle, a connecting pin having a passageway for the axle, and a wheel connecting jacket, wherein the connecting jacket has a first opening for attachment to a body fixture, a second opening positioned to a side of the connecting jacket for selectively receiving the connecting pin, and a semi-circular slot on the second opening for positioning the axle.

2. The wheel assembly of claim 1, wherein the connecting pin comprises a U-shaped spring with a ball on each end.

3. The wheel assembly of claim 1, wherein the connecting pin further comprises a rectangular housing surrounding the U-shaped spring having a square opening above the pinnacle of the U-shaped spring and holes on opposite walls receiving the balls of the U-shaped spring.

4. The wheel assembly of claim 1, wherein the first opening of the connecting jacket opens upward and the second opening of the connecting jacket opens downward.

5. The wheel assembly of claim 1, wherein the second opening of the connecting jacket is shaped to fit the connecting pin.

6. The wheel assembly of claim 3, wherein the second opening of the connecting jacket is square shaped to fit the rectangular housing and has a guidance slot and a pressure sheet on opposite walls corresponding to the balls of the U-shaped spring.

7. A cart comprising a body, at least one wheel connecting jacket, two front wheels, and two rear wheels with at least one wheel having an axle attached to a connecting pin, wherein the connecting jacket has a first opening having a first semi-circular slot on top for positioning a support member for attachment to the body, a second opening positioned to a side of the connecting jacket for selectively receiving the connecting pin, and a second semi-circular slot on the second opening for positioning the axle.

8. The cart of claim 7, wherein the two front wheels are smaller and the two rear wheels are larger.

9. The cart of claim 7, wherein each rear wheel has the axle attached to the connecting pin.

10. The cart of claim 7, wherein the connecting pin comprises a U-shaped spring with a ball on each end.

11. The cart of claim 7, wherein the connecting pin further comprises a rectangular housing surrounding the U-shaped spring having a square opening above the pinnacle of the U-shaped spring and holes on opposite walls receiving the balls of the U-shaped spring.

12. The cart of claim 7, wherein the first opening of the connecting jacket opens upward and the second opening of the connecting jacket opens downward.

13. The cart of claim 7, wherein the second opening of the connecting jacket is shaped to fit the connecting pin.

14. The cart of claim 11, wherein the second opening of the connecting jacket is square shaped to fit the rectangular housing and has a guidance slot and a pressure sheet on opposite walls corresponding to the balls of the U-shaped spring.

15. A method for removably attaching a wheel to a body, the method comprising:
inserting a connecting pin attached to a wheel axle of the wheel into an opening of a connecting jacket attached to the body.

16. The method of claim 15, wherein the connecting pin comprises a U-shaped spring with a ball on each end.

17. The method of claim 16, wherein the connecting pin further comprises a rectangular housing surrounding the U-shaped spring having a square opening above the pinnacle of the U-shaped spring and holes on opposite walls receiving the balls of the U-shaped spring.

18. The method of claim 15, wherein the opening of the connecting jacket is shaped to fit the connecting pin.

19. The method of claim 17, wherein the opening of the connecting jacket is square shaped to fit the rectangular housing and has a guidance slot and a pressure sheet on opposite walls corresponding to the balls of the U-shaped spring.

20. The method of claim 19, further comprising compressing the pressure sheet and the U-shaped spring and pulling the connecting pin from the opening of the connecting jacket for disassembly of the wheel from the connecting jacket of the body.
